(19) United States
(12) Patent Application Publication
(10) Pub. No.: US 2023/0341578 A1
(43) Pub. Date: Oct. 26, 2023

(54) CAPACITANCE SENSING DEVICE AND ELECTRONIC DEVICE INCLUDING CAPACITANCE SENSING DEVICE

(71) Applicant: Samsung Electro-Mechanics Co., Ltd., Suwon-si (KR)

(72) Inventor: Soo Woong LEE, Suwon-si (KR)

(73) Assignee: Samsung Electro-Mechanics Co., Ltd., Suwon-si (KR)

(21) Appl. No.: 17/948,164

(22) Filed: Sep. 19, 2022

(30) Foreign Application Priority Data
Apr. 20, 2022 (KR) 10-2022-0048918
Jun. 30, 2022 (KR) 10-2022-0080360

(51) Int. Cl. G01V 3/08; G04F 10/00

(52) U.S. Cl. CPC G01V 3/088; G04F 10/005

(57) ABSTRACT

A capacitance sensing device including a capacitor configured to have a sensed capacitance value that changes according to a proximity of an object, a sampler configured to sample the sensed capacitance value and output a sampling voltage, a voltage-controlled oscillator configured to convert the sampling voltage output from the sampler into an oscillation signal, and a time-to-digital converter configured to convert the oscillation signal into a digital signal, the digital signal including a sensed capacitance value corresponding to a frequency value of the oscillation signal.

### CROSS-REFERENCE TO RELATED APPLICATIONS

This application claims benefit under 35 USC 119(a) of Korean Patent Application Nos. 10-2022-0048918 filed on Apr. 20, 2022, and 10-2022-0080360 filed on Jun. 30, 2022, in the Korean Intellectual Property Office, the entireties of which are incorporated herein by reference for all purposes.

### BACKGROUND

### 1. Field

This application relates to a capacitance sensing device and an electronic device including a capacitance sensing device.

### 2. Description of Related Art

In general, capacitance sensing circuits may be used in smartphones, various smart devices, or medical devices that determine a touch strength or proximity with respect to an object. Such capacitance sensing circuits are expected to be expanded to a wider field in the future.

In general, in order to implement a capacitance sensing circuit, a method of using an analog-to-digital converter (ADC) and a method of using a sensing oscillator are generally used.

First, a capacitance sensing circuit employing an ADC has a high-resolution characteristic provided by the ADC.

However, the ADC requires a relatively complex and large-sized circuit for realization of high resolution, and accordingly, a current consumption is also high.

A capacitance sensing circuit employing a sensing oscillator may intuitively detect a frequency according to a change in capacitance. The capacitance sensing circuit employing a sensing oscillator has a relatively small circuit size and consumes less power than the capacitance sensing circuit employing an ADC.

However, the capacitance sensing circuit employing a sensing oscillator has a low resolution compared to the case of using an ADC, and since it is necessary to intuitively extract a change in frequency according to a change in capacitance, an additional circuit for signal processing such as signal amplification is needed.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a capacitance sensing device including: a capacitor configured to have a sensed capacitance value that changes according to a proximity of an object; a sampler configured to sample the sensed capacitance value and output a sampling voltage; a voltage-controlled oscillator configured to convert the sampling voltage output from the sampler into an oscillation signal; and a time-to-digital converter configured to convert the oscillation signal into a digital signal, the digital signal including a sensed capacitance value corresponding to a frequency value of the oscillation signal.

The sampler may include a switched capacitor integrator including a low-pass filter configured to block high-frequency noise from the capacitor.

The sampler may be further configured to sequentially perform a sampling mode and an amplification mode in response to a control signal.

The sampler may be further configured to generate a charge voltage by sampling the sensed capacitance value in the sampling mode.

The sampler may be further configured to output the sampling voltage by amplifying the charge voltage in the amplification mode.

The voltage-controlled oscillator may include an oscillator circuit including a ring oscillator or a relaxation oscillator configured to perform an oscillation operation according to the sampling voltage.

The voltage-controlled oscillator further may include a Schmitt trigger connected to an output terminal of the oscillation circuit.

The time-to-digital converter may be further configured to count a frequency value of the oscillation signal using a reference oscillation signal to generate a count value, and detect the sensed capacitance value based on the count value.

In another general aspect, an electronic device includes an electronic device body; and a capacitance sensing device disposed in the electronic device body, wherein the capacitance sensing device includes a capacitor configured to have a sensed capacitance value that changes according to a proximity of an object; a sampler configured to sample the sensed capacitance value and output a sampling voltage; a voltage-controlled oscillator configured to convert the sampling voltage output from the sampler into an oscillation signal; and a time-to-digital converter configured to convert the oscillation signal into a digital signal, the digital signal including a sensed capacitance value corresponding to a frequency value of the oscillation signal.

The sampler may include a switched capacitor integrator including a low-pass filter configured to block high-frequency noise from the capacitor.

The sampler may be further configured to sequentially perform a sampling mode and an amplification mode in response to a control signal provided from the electronic device body.

The sampler may be further configured to generate a charge voltage by sampling the sensed capacitance value in the sampling mode.

The sampler may be further configured to output the sampling voltage by amplifying the charge voltage in the amplification mode.

The voltage-controlled oscillator may include an oscillator circuit including a ring oscillator or a relaxation oscillator configured to perform an oscillation operation according to the sampling voltage.

The voltage-controlled oscillator further may include a Schmitt trigger connected to an output terminal of the oscillation circuit.

The time-to-digital converter may be further configured to count a frequency value of the oscillation signal using a reference oscillation signal to generate a count value, and detect the sensed capacitance value based on the count value.

In another general aspect, a capacitance sensing device includes a capacitor configured to have a sensed capacitance value that changes according to a proximity of an object; a sampler configured to sample the sensed capacitance value and output a sampling voltage; a voltage-controlled oscillator configured to convert the sampling voltage output from the sampler into an oscillation signal; and a time-to-digital converter configured to convert a period of the oscillation signal into a value corresponding to the sensed capacitance value.

The sampler may include an input terminal configured to receive the sensed capacitance value from the capacitor; an output terminal configured to output the sampling voltage; a sample capacitor including a first terminal, and a second terminal connected to a ground; a feedback capacitor; an operational amplifier including an inverting input terminal, a non-inverting input terminal configured to receive a bias voltage, and an output terminal connected to the output terminal of the capacitance sensing device; a first switch connected between the input terminal of the capacitance sensing device and the first terminal of the sample capacitor; a second switch connected between the first terminal of the sample capacitor and the inverting input terminal of the operational amplifier; a third switch connected between the non-inverting input terminal of the operational amplifier and the output terminal of the operational amplifier, and a fourth switch connected in series with the feedback capacitor, the series connection of the fourth switch and the feedback capacitor being connected between the non-inverting input terminal of the operational amplifier and the output terminal of the operational amplifier.

The sampler may be further configured to close the first switch and the third switch and open the second switch and the fourth switch in response to a control signal to operate in a sampling mode, and open the first switch and the third switch and close the second switch and the fourth switch in response to the control signal to operate in an amplification mode.

The time-to-digital converter may be further configured to either count a number of periods of the oscillation signal during a high period of a reference signal, or count a number of periods of the reference signal during a high period of the oscillation signal, wherein the counted number of periods is the value corresponding to the sensed capacitance value.

Other features and aspects will be apparent from the following detailed description, the drawings, and the claims.

### BRIEF DESCRIPTION OF DRAWINGS

FIG. 1 is a diagram of an electronic device according to an example in the present disclosure;

FIG. 2 is a diagram of a capacitance sensing device of FIG. 1.

FIG. 3 is a diagram of a sampler of FIG. 2.

FIGS. 4A and 4B are views illustrating a low pass filter (LPF) included in the sampler of FIG. 3.

FIG. 5 is a diagram illustrating a sampling mode of the sampler of FIG. 3.

FIG. 6 is a diagram illustrating an amplification mode of the sampler of FIG. 3.

FIG. 7 is a diagram illustrating an example of a voltage-controlled oscillator (VCO) of FIG. 2.

FIG. 8 is a diagram illustrating another example of the VCO of FIG. 2.

FIG. 9 is a diagram illustrating another example of the VCO of FIG. 2.

FIG. 10 is an input-output characteristic graph of the VCO of FIG. 2.

FIG. 11 is a diagram of a time-to-digital converter (TDC) of FIG. 2.

FIGS. 12A and 12B are views illustrating examples of a counting operation of the TDC of FIG. 11.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

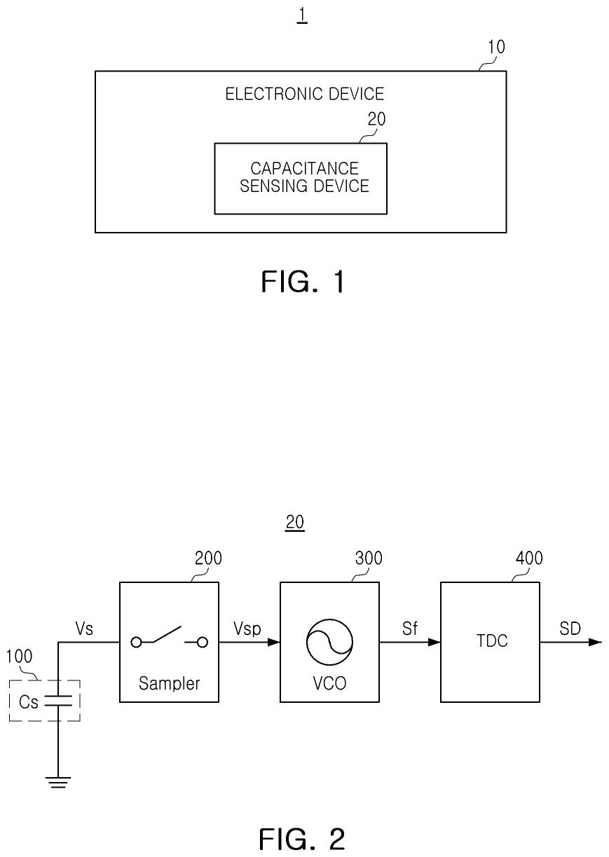

FIG. 1 is a diagram of an electronic device according to an example in the present disclosure.

Referring to FIG. 1, an electronic device 1 according to an example in the present disclosure may include an electronic device body 10 and a capacitance sensing device 20 disposed in the electronic device body 10.

For example, the electronic device 1 may be an electronic device needing the capacitance sensing device 20. For example, the electronic device 1 may be a mobile device, such as a smartphone, but is not limited thereto.

FIG. 2 is a diagram of the capacitance sensing device of FIG. 1.

Referring to FIG. 2, the capacitance sensing device 20 may include a capacitor 100, a sampler 200, a voltage-controlled oscillator (VCO) 300, and a time-to-digital converter (TDC) 400.

The capacitor 100 may include a sensed capacitance value Cs changing according to proximity of an object. As an example, the capacitor 100 may include at least one capacitor element providing a sensed capacitance value Cs changing according to proximity of an object. For example, the sensed capacitance value Cs may increase as a distance to an object decreases.

In the present disclosure, proximity is a concept including a physical touch, a touch intensity, and a short-range approach, and a capacitance sensing device for sensing proximity including a physical touch or a short-range approach of an object with respect to the electronic device 1 is proposed.

The sampler 200 may sample the sensed capacitance value Cs and provide a sampling voltage Vsp. For example, the sampler 200 may sample a sensing voltage Vs corresponding the sensed capacitance value Cs and provide the sampling voltage Vsp corresponding to the sensed capacitance value Cs.

For example, the sampler 200 may be implemented as a circuit including an operation of sampling the sensed capacitance value Cs and an operation of amplifying the sampled value, but is not limited thereto.

The VCO 300 may convert the sampling voltage Vsp from the sampler 200 into an oscillation signal Sf. For example, the VCO 300 may generate the oscillation signal Sf having a frequency value corresponding to the sampling voltage Vsp from the sampler 200.

In addition, the TDC 400 converts the oscillation signal Sf into a digital signal SD, and the digital signal SD may include a sensed capacitance value Cs corresponding to the frequency value of the oscillation signal Sf.

For example, the TDC 400 may output the digital signal SD having a digital value corresponding to the frequency value of the oscillation signal Sf.

In each drawing of the present disclosure, unnecessary redundant descriptions of the same reference numerals and components having the same function may be omitted, and only differences may be described with respect to each drawing.

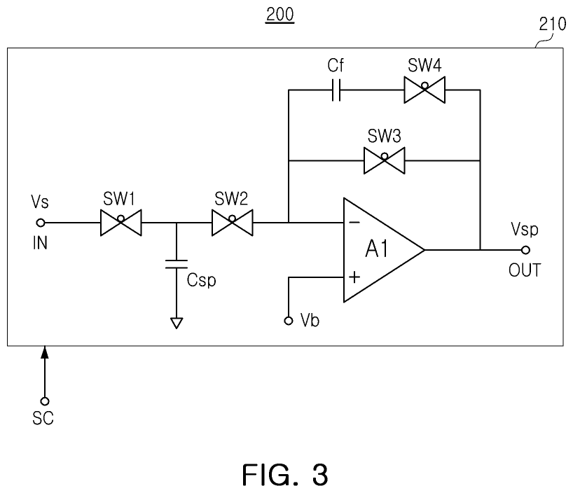

FIG. 3 is a diagram of the sampler of FIG. 2.

Referring to FIGS. 2 and 3, the sampler 200 may include a switched capacitor integrator 210 including a low-pass filter (LPF) blocking high-frequency noise from the capacitor 100.

The switched capacitor integrator 210 may operate in a sampling mode and an amplification mode, and for example, in response to a control signal SC provided from the outside, the switched capacitor integrator 210 may operate in the sampling mode and the amplification mode sequentially.

For example, since the switched capacitor integrator 210 includes an LPF, the switched capacitor integrator 210 may block high-frequency noise generated in a set using a radio frequency (RF) frequency.

For example, referring to FIG. 3, the switched capacitor integrator 210 of the sampler 200 may include a sample capacitor Csp, a feedback capacitor Cf, an operational amplifier A1, a first switch SW1, a second switch SW2, a third switch SW3, and a fourth switch SW4.

The sample capacitor Csp may be connected between the first switch SW1 connected to the input terminal IN and the second switch SW2 connected to the operational amplifier A1.

The operational amplifier A1 may include an inverting input terminal (−) connected to the second switch SW2, a non-inverting input terminal (+) to which a bias voltage Vb is applied, and an output terminal outputting a sampling voltage Vsp to an output terminal OUT.

The third switch SW3 may be connected between the inverting input terminal (−) and the output terminal of the operational amplifier A1, and the fourth switch SW4 and the feedback capacitor Cf may be connected to each other in series and connected in parallel with the third switch SW3.

For example, the first switch SW1, the second switch SW2, the third switch SW3, and the fourth switch SW4 described above may be an electronic switch element, such as a diode, a transistor, or a transmission gate.

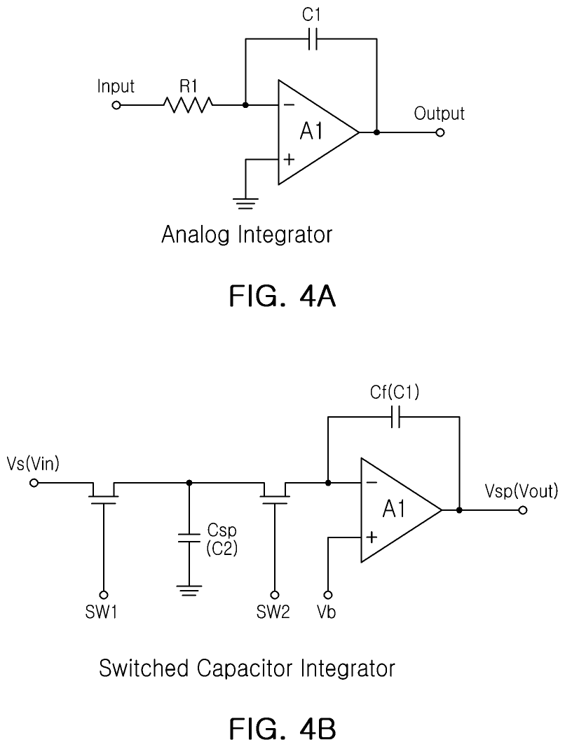

FIGS. 4A and 4B are views illustrating the LPF included in the sampler of FIG. 3.

When a resistor R1 is connected between the inverting input terminal (−) of the operational amplifier A1 and an input terminal Input and a capacitor C1 is connected between the inverting input terminal (−) of the operational amplifier A1 and an output terminal Output, an analog integrator illustrated in FIG. 4A may include an LPF having a bandwidth frequency (fbw=1/(2*π*R1*C1)).

A switched capacitor integrator of the present disclosure illustrated in FIG. 4B may include an LPF as illustrated in FIG. 4A.

In other words, the switched capacitor integrator illustrated in FIG. 4B may include C1 (=Cf), C2 (=Csp), the operational amplifier A1, and a plurality of switches SW1 and SW2, and here, C1 (=Cf) and C2 (=Csp) may determine the bandwidth frequency fbw of the LPF, and the bandwidth frequency fbw may be expressed by Equation 1 below.

fbw=(fs*C2)/(2*π*C1) (1)

In Equation 1, fs is a sampling clock frequency.

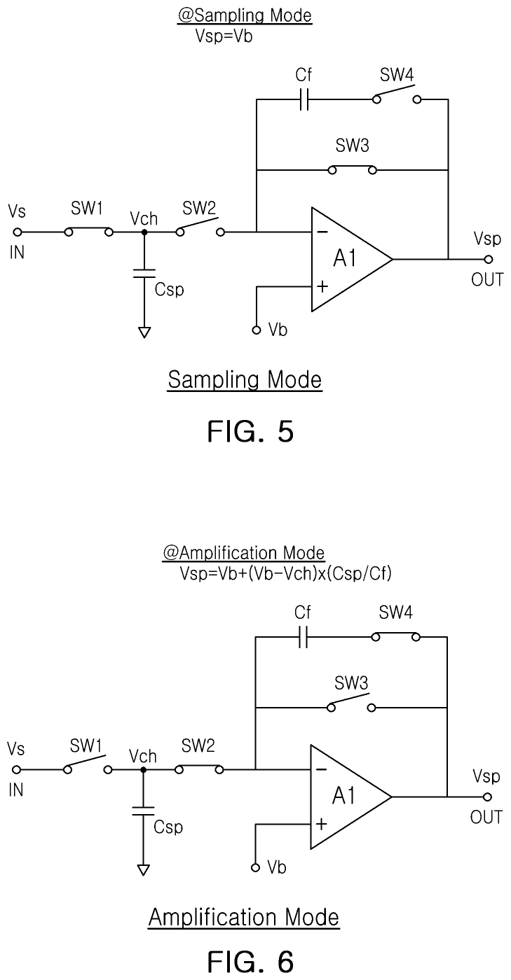

FIG. 5 is a diagram illustrating a sampling mode of the sampler of FIG. 3.

Referring to FIGS. 3 and 5, the sampler 200 may generate a charge voltage Vch by sampling a sensing voltage Vs corresponding to the sensed capacitance value Cs in the sampling mode.

For example, in the sampler 200 of FIG. 3, when the first switch SW1 and the third switch SW3 are turned on by a control signal SC and the second switch SW2 and the fourth switch SW4 are turned off, the sampler 200 may operate in the sampling mode to sample the sensing voltage Vs corresponding to the sensed capacitance value Cs to generate the charge voltage Vch charged in the sample capacitor Csp.

FIG. 6 is a diagram illustrating an amplification mode of the sampler of FIG. 3.

Referring to FIGS. 3 and 6, the sampler 200 may amplify the charge voltage Vch and output the sampling voltage Vsp in the amplification mode.

For example, in the sampler 200 of FIG. 3, when the first switch SW1 and the third switch SW3 are turned off by the control signal SC and the second switch SW2 and the fourth switch SW4) is turned on, the sampler 200 may operate in the amplification mode to amplify the charge voltage Vch charged in the sample capacitor Csp to output the sampling voltage Vsp.

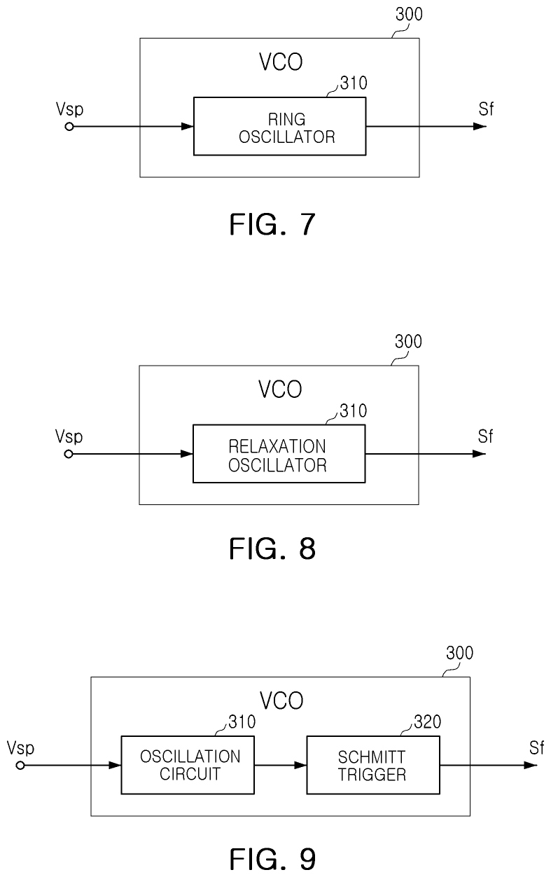

FIG. 7 is a diagram illustrating an example of the VCO of FIG. 2, FIG. 8 is a diagram illustrating another example of the VCO of FIG. 2, and FIG. 9 is a diagram illustrating another example of the VCO of FIG. 2.

Referring to FIGS. 7 and 8, the VCO 300 may include an oscillation circuit 310.

The oscillation circuit 310 may include a ring oscillator (refer to FIG. 7) or a relaxation oscillator (refer to FIG. 8) performing an oscillation operation according to the sampling voltage Vsp.

Referring to FIG. 9, the VCO 300 may include an oscillation circuit 310 and a Schmitt trigger 320.

The Schmitt trigger 320 may be connected to an output terminal of the oscillation circuit 310 for stable oscillation and may operate on an output signal from the oscillation circuit 310 to provide a stable output signal.

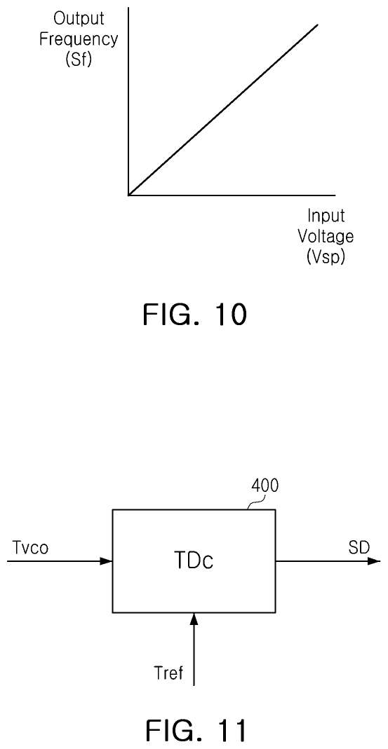

FIG. 10 is an input-output characteristic graph of the VCO of FIG. 2.

Referring to FIG. 10, it can be seen that the sampling voltage Vsp input to the VCO 300 and the oscillation signal Sf output from the VCO 300 are in a linear proportional relationship.

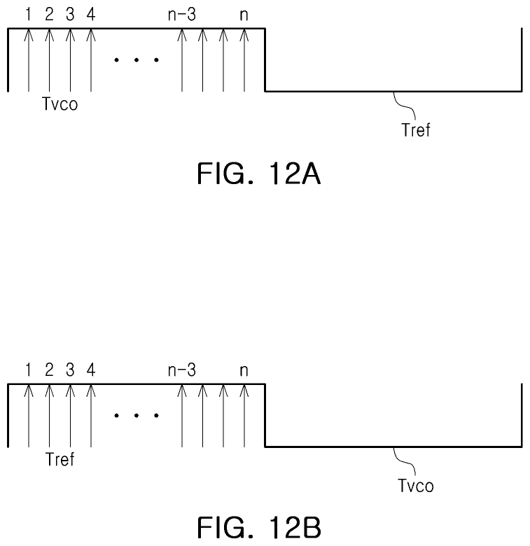

FIG. 11 is a diagram illustrating an example of the TDC of FIG. 2, and FIGS. 12A and 12B are views illustrating examples of a count operation of the TDC of FIG. 11.

Referring to FIGS. 11, 12A, and 12B, the TDC 400 may count the frequency value of the oscillation signal Sf using a reference oscillation signal to generate a count value, and detect the sensed capacitance value Cs based on the count value.

That is, the TDC 400 may compare a period Tvco corresponding to the frequency of the oscillation signal Sf output from the VCO 300 with a period Tref corresponding to a frequency of a reference signal and output a final digital signal SD having a comparison value.

For example, the frequency of the oscillation signal Sf may be higher than the frequency of the reference signal, and accordingly, the period Tvco corresponding to the frequency of the oscillation signal Sf may be shorter than the period Tref corresponding to the frequency of the reference signal, and as a result, counting may be performed using the period Tvco of the oscillation signal Sf with respect to the period Tref of the reference signal.

Referring to FIG. 12A, in the TDC, counting is performed by counting how many periods Tvco are included in a high interval of the period Tref, and the counted number of the periods Tvco is proportional to the sensed capacitance value Cs.

In FIG. 12A, a case in which a period of a clock of Tvco is shorter than a period of Tref (i.e., a case in which the frequency of the clock of Tvco is higher than a frequency of the clock of Tref) is described, but the present disclosure is not limited thereto.

Referring to FIG. 12B, it is also possible that the clock of Tvco has a longer period than the clock of Tref (i.e., the clock of Tvco has a higher frequency than the clock of Tref).

That is, there is no need to restrict one of Tvco and Tref to having have a higher frequency or lower frequency than the other.

A brief description of the operation of the TDC is as follows.

In FIG. 12A, the number of periods Tvco corresponding to the frequency of the oscillation signal Sf is counted during the high period of the period Tref corresponding to the frequency of the reference signal. Assuming that the period Tref corresponding to the frequency of the reference signal is always constant, the counted number of the periods Tvco corresponding to the frequency of the oscillation signal Sf is proportional to the clock frequency of the VCO 300 at the front stage and an output from the VCO 300 is proportional to the sensed capacitance value Cs.

For example, if the counted number of the periods Tvco increases, it may be determined that the sensed capacitance value Cs has increased by a corresponding proportional amount, and if the counted number of the periods Tvco decreases, it may be determined that the sensed capacitance value Cs has decreased by a corresponding proportional amount.

That is, a relative change amount of the sensed capacitance value Cs is estimated by a change in the counted number of the periods Tvco corresponding to the frequency of the oscillation signal Sf in the TDC 400.

In FIG. 12B, the number of periods Tref corresponding to the frequency of the reference signal is counted during the high period of the period Tvco corresponding to the frequency of the oscillation signal Sf. Assuming that the period Tref corresponding to the frequency of the reference signal is always constant, the counted number of the periods Tref is proportional to the clock frequency of the VCO 300 at the front stage and an output from the VCO 300 is proportional to the sensed capacitance value Cs.

For example, if the counted number of the periods Tref increases, it may be determined that the sensed capacitance value Cs has decreased by a corresponding proportional amount, and if the counted number of the periods Tref decreases, it may be determined that the sensed capacitance value Cs has increased by a corresponding proportional amount.

That is, a relative change amount of the sensed capacitance value Cs is estimated by a change in the counted number of the periods Tvco corresponding to the frequency of the oscillation signal Sf in the TDC 400.

The examples of the capacitance sensing device described above have the advantage of significantly reducing a circuit size and a consumption, which are advantages of the existing capacitance sensing circuit employing a sensing oscillator, while maintaining a high resolution, which is an advantage of the existing capacitance sensing circuit employing an ADC.

According to the examples in the present disclosure, a capacitance sensing device may be implemented to have a smaller size than the existing capacitance sensing device employing an ADC, while maintaining the high resolution and high sensitivity characteristics, which are advantages of the existing capacitance sensing circuit employing the ADC, thereby reducing current consumption.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A capacitance sensing device comprising:
a capacitor configured to have a sensed capacitance value that changes according to a proximity of an object;
a sampler configured to sample the sensed capacitance value and output a sampling voltage;
a voltage-controlled oscillator configured to convert the sampling voltage output from the sampler into an oscillation signal; and
a time-to-digital converter configured to convert the oscillation signal into a digital signal, the digital signal comprising a sensed capacitance value corresponding to a frequency value of the oscillation signal.

2. The capacitance sensing device of claim 1, wherein the sampler comprises a switched capacitor integrator comprising a low-pass filter configured to block high-frequency noise from the capacitor.

3. The capacitance sensing device of claim 1, wherein the sampler is further configured to sequentially perform a sampling mode and an amplification mode in response to a control signal.

4. The capacitance sensing device of claim 3, wherein the sampler is further configured to generate a charge voltage by sampling the sensed capacitance value in the sampling mode.

5. The capacitance sensing device of claim 4, wherein the sampler is further configured to output the sampling voltage by amplifying the charge voltage in the amplification mode.

6. The capacitance sensing device of claim 1, wherein the voltage-controlled oscillator comprises an oscillator circuit comprising a ring oscillator or a relaxation oscillator configured to perform an oscillation operation according to the sampling voltage.

7. The capacitance sensing device of claim 6, wherein the voltage-controlled oscillator further comprises a Schmitt trigger connected to an output terminal of the oscillation circuit.

8. The capacitance sensing device of claim 1, wherein the time-to-digital converter is further configured to count a frequency value of the oscillation signal using a reference oscillation signal to generate a count value, and detect the sensed capacitance value based on the count value.

9. An electronic device comprising:
an electronic device body; and
a capacitance sensing device disposed in the electronic device body,
wherein the capacitance sensing device comprises:
a capacitor configured to have a sensed capacitance value that changes according to a proximity of an object;
a sampler configured to sample the sensed capacitance value and output a sampling voltage;
a voltage-controlled oscillator configured to convert the sampling voltage output from the sampler into an oscillation signal; and
a time-to-digital converter configured to convert the oscillation signal into a digital signal, the digital signal comprising a sensed capacitance value corresponding to a frequency value of the oscillation signal.

10. The electronic device of claim 9, wherein the sampler comprises a switched capacitor integrator comprising a low-pass filter configured to block high-frequency noise from the capacitor.

11. The electronic device of claim 9, wherein the sampler is further configured to sequentially perform a sampling mode and an amplification mode in response to a control signal provided from the electronic device body.

12. The electronic device of claim 11, wherein the sampler is further configured to generate a charge voltage by sampling the sensed capacitance value in the sampling mode.

13. The electronic device of claim 12, wherein the sampler is further configured to output the sampling voltage by amplifying the charge voltage in the amplification mode.

14. The electronic device of claim 9, wherein the voltage-controlled oscillator comprises an oscillator circuit comprising a ring oscillator or a relaxation oscillator configured to perform an oscillation operation according to the sampling voltage.

15. The electronic device of claim 14, wherein the voltage-controlled oscillator further comprises a Schmitt trigger connected to an output terminal of the oscillation circuit.

16. The electronic device of claim 9, wherein the time-to-digital converter is further configured to count a frequency value of the oscillation signal using a reference oscillation signal to generate a count value, and detect the sensed capacitance value based on the count value.

17. A capacitance sensing device comprising:
a capacitor configured to have a sensed capacitance value that changes according to a proximity of an object;
a sampler configured to sample the sensed capacitance value and output a sampling voltage;
a voltage-controlled oscillator configured to convert the sampling voltage output from the sampler into an oscillation signal; and
a time-to-digital converter configured to convert a period of the oscillation signal into a value corresponding to the sensed capacitance value.

18. The capacitance sensing device of claim 17, wherein the sampler comprises:
an input terminal configured to receive the sensed capacitance value from the capacitor;
an output terminal configured to output the sampling voltage;
a sample capacitor comprising a first terminal, and a second terminal connected to a ground;
a feedback capacitor;
an operational amplifier comprising an inverting input terminal, a non-inverting input terminal configured to receive a bias voltage, and an output terminal connected to the output terminal of the capacitance sensing device;
a first switch connected between the input terminal of the capacitance sensing device and the first terminal of the sample capacitor;
a second switch connected between the first terminal of the sample capacitor and the inverting input terminal of the operational amplifier;
a third switch connected between the non-inverting input terminal of the operational amplifier and the output terminal of the operational amplifier, and
a fourth switch connected in series with the feedback capacitor, the series connection of the fourth switch and the feedback capacitor being connected between the non-inverting input terminal of the operational amplifier and the output terminal of the operational amplifier.

19. The capacitance sensing device of claim 18, wherein the switched capacitor integrator is configured to:
close the first switch and the third switch and open the second switch and the fourth switch in response to a control signal to operate in a sampling mode, and
open the first switch and the third switch and close the second switch and the fourth switch in response to the control signal to operate in an amplification mode.

20. The capacitance sensing device of claim 17, wherein the time-to-digital converter is further configured to either count a number of periods of the oscillation signal during a high period of a reference signal, or count a number of periods of the reference signal during a high period of the oscillation signal,
wherein the counted number of periods is the value corresponding to the sensed capacitance value.
